(19) United States
(12) Patent Application Publication
(10) Pub. No.: US 2025/0162491 A1
(43) Pub. Date: May 22, 2025

(54) SECUREMENT ASSEMBLY FOR TRAILER CARGO

(71) Applicant: Western Trailer Co., Boise, ID (US)

(72) Inventor: Todd H. Swanstrom, Boise, ID (US)

(21) Appl. No.: 18/414,282

(22) Filed: Jan. 16, 2024

Related U.S. Application Data
(60) Provisional application No. 63/600,559, filed on Nov. 17, 2023.

(51) Int. Cl. B60P 7/135

(52) U.S. Cl. CPC B60P 7/135

(57) ABSTRACT

A load securement assembly for securing cargo to a trailer, such as an A-frame vehicle trailer, is provided. The load securement assembly can include a pedestal assembly configured to support the base of the cargo and can have a first side plate and a second side plate arranged in a spaced apart configuration, and a plurality of tubes extending therethrough and spaced apart from each other. The load securement assembly can further include a stop block assembly configured to prevent translation of the cargo in a load securement direction. The stop block assembly can have a rod received within one of the plurality of tubes, and a stop block slidably associated with the rod, the stop block having a rod lock to releasably fix the stop block to the rod at an intermediate position. The stop block can be configured to prevent translation of the cargo in the load securement direction.

### CROSS REFERENCE TO RELATED APPLICATION

This application claims the benefit of Provisional Application No. 63/600,559, filed Nov. 17, 2023, the entire disclosure of which is hereby incorporated by reference herein for all purposes.

### FIELD OF DISCLOSURE

The present disclosure relates generally to the field of transportation, addressing challenges associated with the secure and efficient transport of large rectangular plates (e.g., glass, stone, metal, etc.). More particularly, the present disclosure pertains to improvements in securement functionality for A-frame style truck trailers utilized for the transportation of large rectangular plates, enhancing safety, reducing damage, and improving overall logistical efficiency.

### BACKGROUND

The transportation of rectangular plates, such as glass, stone, and metal plates, poses unique challenges due to their configuration with respect to the A-frame trailer transport. During loading, plates of different overall lengths are often placed on the A-frame trailer and leaned against center supports, and load balancing requirements can dictate that the forward edge of each of the different plates are not aligned or placed against the front portion of the load area. As such, conventional A-frame truck trailers lack specialized features to adequately secure and protect these panels, particularly during heavy braking events that tend to shift the panels toward the front of the trailer, leading to increased risks of breakage, chipping, and other forms of damage. Existing solutions often involve cumbersome and time-consuming manual securement procedures, which not only increase the likelihood of accidents but also result in operational inefficiencies.

Furthermore, conventional transport A-frame trailers may lack the necessary structural elements and securing mechanisms tailored specifically for the dimensions and fragility of glass and stone plates. As a consequence, the industry faces challenges in meeting the demand for streamlined and secure rectangular panel transportation, particularly as glass and stone plates continue to be essential components in various industries, including commercial and residential construction, fabrication, machining, manufacturing, automotive, etc. There is a need, therefore, for an improved plate securement device for rectangular plate transport A-frame truck trailers that addresses the shortcomings of existing solutions, providing enhanced safety, efficiency, and versatility in the transportation of large rectangular plates of various sizes and types.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1A depicts one example of an A-frame truck trailer having a plurality of load securement assemblies, shown in perspective view, in which technologies and/or methodologies of the present disclosure may be employed;

FIG. 1B is a detail perspective view of the plurality of load securement assemblies of FIG. 1A;

FIG. 2 is a detail view of a load securement assembly in accordance with embodiments of the present disclosure, with other portions of the A-frame truck trailer hidden for clarity purposes;

FIG. 3A is a perspective view of a pedestal assembly of the load securement assembly of FIG. 2;

FIG. 3B is a side view of a pedestal assembly of the load securement assembly of FIG. 2;

FIG. 4A is a perspective view of a stop block assembly of the load securement assembly of FIG. 2, in accordance with embodiments of the present disclosure;

FIG. 4B is a side view of the stop block assembly of FIG. 4A, shown in an extended position; and

FIG. 4C is a side view of the stop block assembly of FIG. 4A, shown in an intermediate position.

### DETAILED DESCRIPTION

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

As will be described in more detail below, the present disclosure provides examples of load securement assemblies for use with, e.g., A-frame style truck trailers for transport of large rectangular plates and other related cargo. The load securement assemblies can be configured to prevent the forward shift of the large rectangular plates during braking maneuvers of the transport vehicle. In some embodiments, the load securement assemblies are configured to prevent this forward shift for a variety of different rectangular plate lengths, for example, when transporting different sizes rectangular plates on the same trailer. During transport of this type of cargo, conventional securement techniques provide secure lateral support, but can result in a forward shift of the cargo during a heavy braking event by the transport vehicle, which can compromise safety by affecting the load balance, and/or damage the cargo. Embodiments of the present disclosure provide modular load securement devices that can be adjusted to accommodate various cargo configurations, e.g., large rectangular plates having different overall lengths in the longitudinal direction of the transport vehicle.

The load securement assemblies disclosed herein include a pedestal assembly having apertures configured to receive a rod therein, and slidable stop block assemblies that can be adjustably fixed along the rod to secure the rectangular plates to the A-frame truck trailer. In a typical loading configuration of the cargo, larger plates are placed laterally inward against the A-frame supports and the plates are stacks outwardly in descending size. In this regard, the load securement assemblies can be adapted to secure each of the sizes of rectangular plates without the leading edge of the plates being aligned. Embodiments of the present disclosure allow the cargo to be load balanced for optimum trailer loading configurations, rather than requiring alignments of the leading edge of the rectangular plates. After the rectangular plates are loaded, the adjustable stop block assemblies can be slid against the leading edge of the rectangular plates to secure the cargo from forward shift during heavy deceleration caused by a heavy braking event.

Although embodiments of the present disclosure may be described with reference to load securement assembly configurations for A-frame style truck trailers suitable for commercial transport, one skilled in the relevant art will appreciate that the disclosed embodiments are illustrative in nature and therefore should not be construed as limited to such an application. It should therefore be apparent that the disclosed technologies and methodologies have wide application, and therefore may be suitable for use with many types of cargo transport configurations, including different types of trailers, or train cars, modular cargo units for aircraft, and the like. Accordingly, the following descriptions and illustrations herein should not limit the scope of the claimed subject matter.

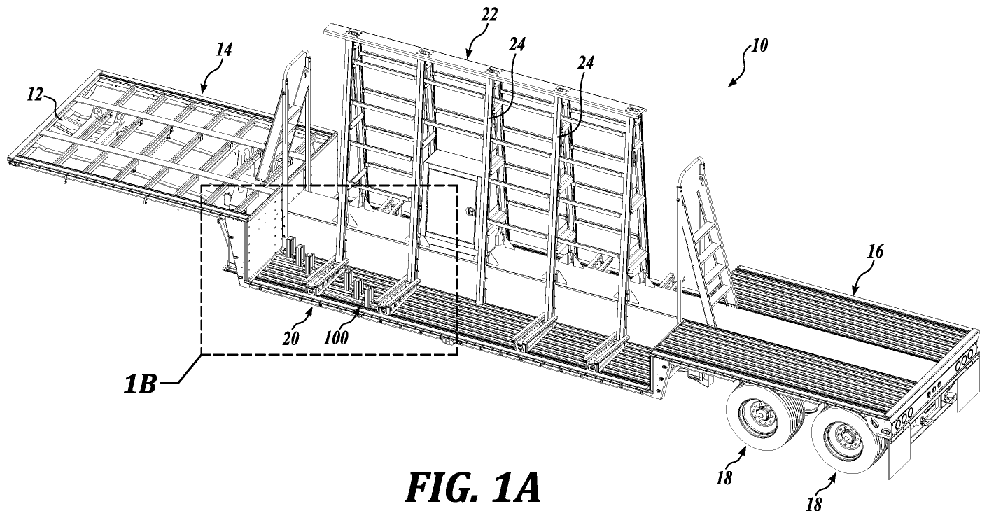

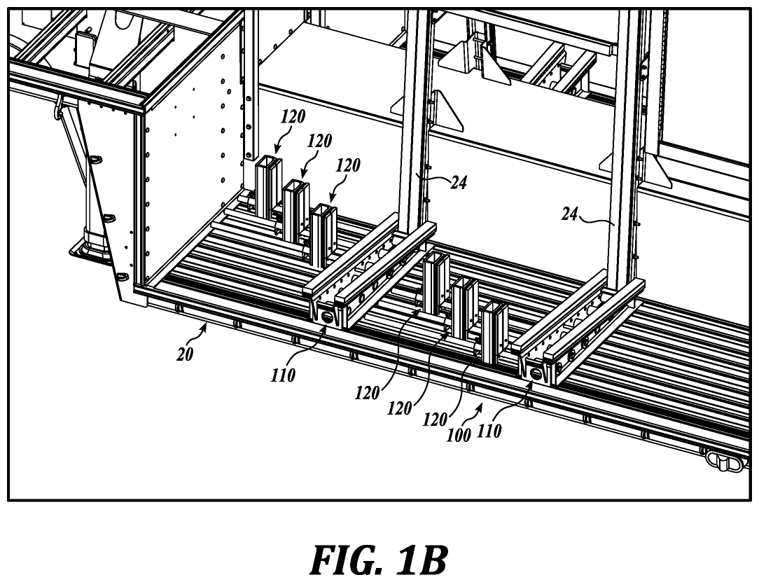

FIG. 1A depicts one example of an A-frame truck trailer 10 (“trailer 10”) for transportation of rectangular plates (not shown) having a plurality of load securement assemblies 100 (“assemblies 100”), shown in perspective view, in which technologies and/or methodologies of the present disclosure may be employed, and FIG. 1B is a detail perspective view of the assemblies 100. The trailer 10 can include a fifth-wheel coupling kingpin 12 configured to provide an articulable and releasable coupling to the transport vehicle, e.g., a tractor-trailer. The trailer 10 can further include a forward portion 14, a central platform portion 20 having an A-frame structure 22, and an aft platform portion 16 having axle and wheel assemblies 18. The A-frame structure 22 can include vertical support members 24 to provide lateral support to the rectangular plates, which are generally secured to the A-frame structure 22 in a nearly vertical orientation (e.g., from about 5° to) 20°.

As shown in FIG. 1B, each of the assemblies 100 can include a pedestal assembly 110 positioned with respect to the vertical support members 24 and configured to support the base of the rectangular plates, and a plurality of stop block assemblies 120 slidingly associated with the pedestal assembly 110 and configured to abut the leading edge (toward the forward portion 14) of the rectangular plates. As will be described in detail below, the stop block assemblies 120 have features that lock the position of a stop block with respect to the pedestal assembly 110 in a forward direction toward the forward portion 14. When the stop block assembly 120 is positioned to abut a rectangular plate in the cargo, the locked position prevent forward shift of the rectangular plate during a braking event of the transport vehicle. In the illustrated embodiments, each of the pedestal assemblies 110 includes six positions for adjusting the location of the stop block assemblies 120 in the lateral direction with respect to the A-frame structure 22. The illustrative example in FIGS. 1A and 1B shows a configuration of the assemblies 100 suitable for use when the largest rectangular plates are arranged inward toward the A-frame structure 22, and descending size plates are arranged laterally outward from the frame structure 22. In this regard, the most inward stop block assembly 120 is positioned furthest forward compared to the other stop block assemblies 120, and each stop block assembly 120 is positioned further rearward away from the forward portion 14 in descending order laterally outward.

In other configurations, the stop block assemblies 120 can be arranged in any suitable position with respect to the loading configuration of the rectangular plates. For example, heavier material plates may be located more inward toward the A-frame structure 22, but may have a shorter overall length dictating that the stop block assembly 120 corresponding to that shorter overall length plate may be positioned rearward of a laterally outward stop block assembly 120. In other embodiments, multiple stop block assemblies 120 can be positioned at the same longitudinal position with respect to the trailer 10, such as when multiple plates all have the same length or their leading edges are aligned. Further, although three stop block assemblies 120 are shown with each of the two pedestal assemblies 110, other configurations can have greater or fewer stop block assemblies 120 per pedestal assembly 110. Likewise, the pedestal assemblies 110 can have greater or fewer than six positions for adjusting the location of the stop block assemblies 120.

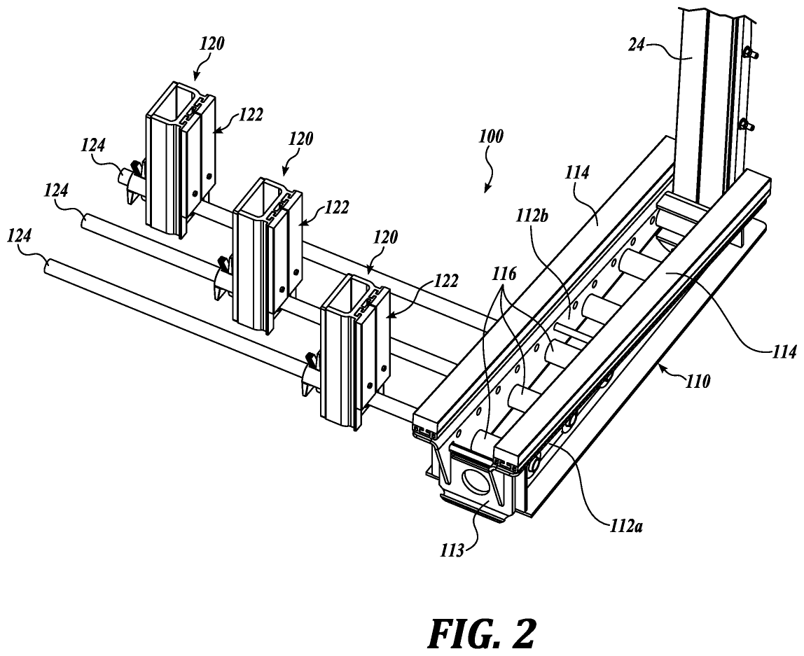

FIG. 2 is a detail view of one of the assemblies 100 in accordance with embodiments of the present disclosure, with other portions of the trailer 10 hidden for clarity purposes. As shown, the pedestal assembly 110 can further include a first side plate 112a and a second side plate 112b in a spaced apart configuration. The pedestal assembly 110 can include pads 114 atop the first and second side plates 112a and 112b and configured to support the bottom edge of the rectangular plates during transport. In this regard, the pads 114 can be made of a protective material with respect to the rectangular plates, such as plastic, rubber, etc. The pedestal assembly 110 can further include an outside plate 113 to provide structure between the first and second side plates 112a and 112b, and can include tubes 116 configured to receive a portion of the stop block assembly 120 therethrough. Each of the tubes 116 can be spaced apart along the length of the pedestal assembly 110 to provide different lateral positions for the stop block assemblies 120 with respect to the A-frame structure 22. As noted above, greater or fewer then six tubes 116 can be included in each of the pedestal assemblies 110 to provide a suitable amount of lateral adjustment of the stop block assemblies 120. Although the tubes 116 are shown as circular tubes, any shape of tube is also within the scope of the present disclosure, including square, hexagonal, polygonal, L-shaped, U-shaped, etc.

The illustrated embodiment in FIG. 2 shows a configuration of the stop block assemblies 120 positioned in the three laterally outermost tubes 116, with descending forward positions. As described above, the illustrated configuration as one example of an arrangement of the assembly 100, and other suitable arrangements are also within the scope of the present disclosure. The stop block assemblies 120 include stop blocks 122 that are slidably associated with rods 124 inserted through the tubes 116 of the pedestal assembly 110. The stop blocks 122 can be fixed along the rods 124 at any position to correspond to the length of the rectangular plates carried by the trailer 10. For example, for longer rectangular plates or plates with the leading edge positioned more forwardly, the stop block 122 can be positioned near the forward end of the rod 124 such that the stop block 122 is furthest away from the pedestal assembly 110. Similarly, for shorter rectangular plates or plates with their leading edge positioned more rearwardly, the stop block 122 can be positioned toward the rearward end of the rod such that the stop block 122 is closer to the pedestal assembly 110. In this manner, the position of the stop block 122 along the rod 124 has non-discrete adjustment or any position of the leading edge of the rectangular plates within the adjustment range of the stop block 122.

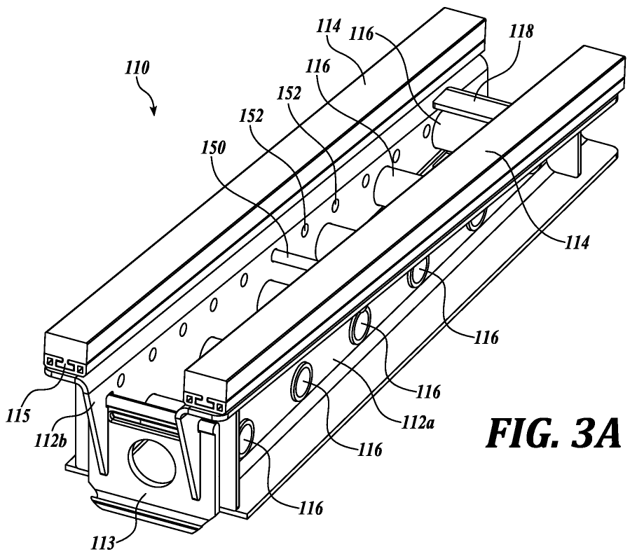

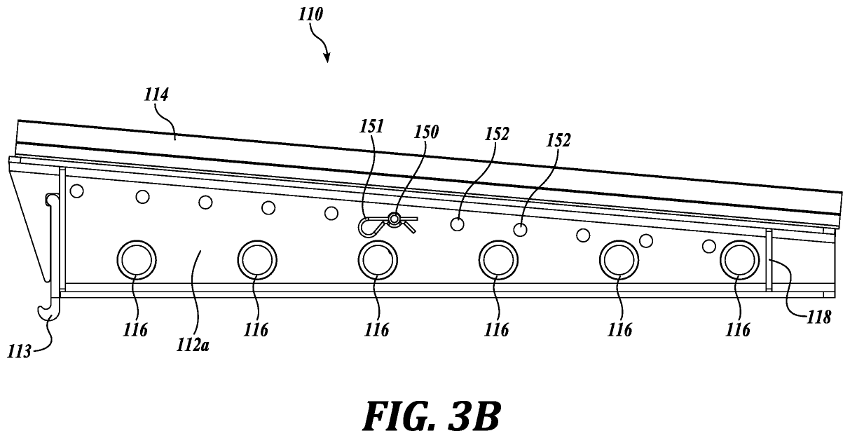

FIGS. 3A and 3B are perspective and side views, respectively, of the pedestal assembly 110 in accordance with embodiments of the present disclosure. In addition to the features described above, the pedestal assembly 110 can further include an inside plate 118 to provide structure between the first and second side plates 112a and 112b, and an array of apertures 152 along the length of the first and second side plates 112a and 112b that are configured to receive a pin 150 therethrough. The pin 150 can be axially locked with respect to the first and second side plates 112a and 112b by a locking pin 151 (shown as a cotter pin 151, as an example). In some embodiments, the pin 150 can be positioned in any of the apertures 152 to provide an attachment point for a securement strap or other device to secure the rectangular plates to the A-frame structure 22. In this regard, when the number and/or thickness of rectangular plates causes the load to be relatively wide, the pin 150 can be positioned in one of the laterally outward apertures 152 (e.g., near the left side of FIG. 3B), and when the load is relatively narrow, the pin 150 can be positioned in one of the laterally inward apertures 152 (e.g., near the right side of FIG. 3B).

In some embodiments, because the pads 114 can be made of a protective material with respect to the rectangular plates, such as plastic, rubber, etc., the pads 114 may wear out and require replacement or different pad material may be changed depending on rectangular plate material and/or loading configurations. In this regard, the pads 114 can include a structural engagement tab 115 configured to removably couple the pads 114 to the first and second side plates 112a and 112b in a sliding manner. As an example, to replace one of the pads 114, the pad 114 can be slid laterally outward compared to the side plate 112 until the tab 115 disengages from the side plate 112. A replacement pad 114 (new or different material) can then be slid laterally inward compared to the side plate 112 to engage the tab 115 to the side plate 112. In other embodiments, other coupling configurations between the pads 114 and the first and second side plates 112a and 112b are within the scope of the present disclosure.

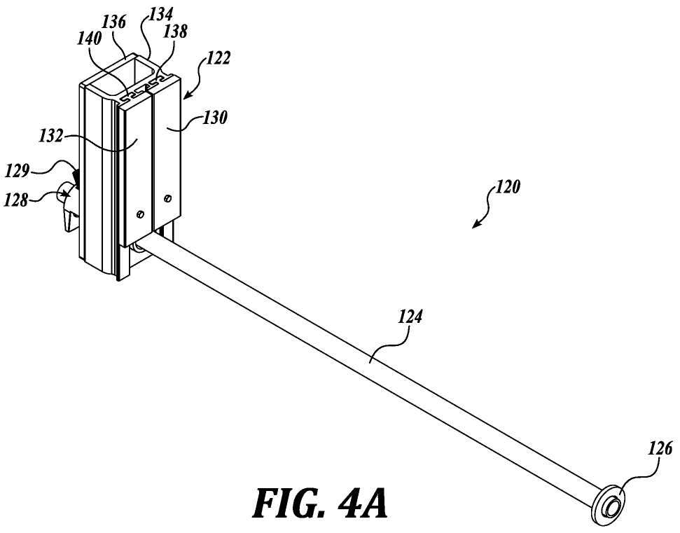

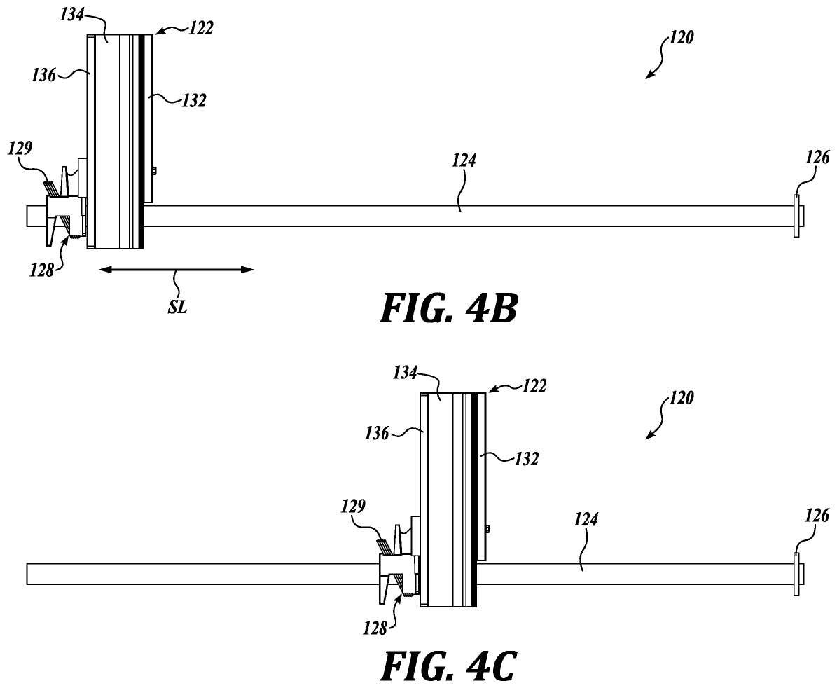

FIG. 4A is a perspective view and FIGS. 4B and 4C are side views of one stop block assembly 120 of the plurality of stop block assemblies 120 slidingly associated with each pedestal assembly 110. The stop block assembly 120 can include a stop washer 126 at a rearward end of the rod 124 to prevent forward movement of the stop block assembly 120 with respect to the pedestal assembly 110, e.g., during a heavy braking event of the transport vehicle. In this regard, the stop washer 126 abuts a rearward-facing side of one of the tubes 116 of the pedestal assembly 110 and prevents forward movement of the rod 124, and thereby the stop block 122. Although not shown, the stop washer 126 can be fixedly coupled to the rod 124 any suitable manner, e.g., by welding, threads, a locking pin, a fastener, etc.

The stop block 122 is slidingly associated with the rod 124 to adjust for the position of the leading edge of the rectangular plates in the cargo of the trailer 10. In this regard, forward movement of the stop block 122 can be prevented (to prevent forward shift of the rectangular plates) by a rod locking assembly 128 having a releasable locking member 129. During use, the rod locking assembly 128 positioned along the rod 124 adjacent to the stop block 122 and lock the position of the stop block 122 such that the stop block 122 cannot move forward with respect to the rod 124. In these embodiments, the rod locking assembly 128 is slidable along the rod 124 and the releasable locking member 129 engages the rod 124 to lock the position of the rod locking assembly 128. In some embodiments, the releasable locking member 129 engages the rod 124 with friction, e.g., by a friction plate stack as shown. In other embodiments, the releasable locking member 129 can engage the rod 124 and any suitable manner.

The stop block 122 can include a stop block body 134 having a plate 136 for engaging the rod locking assembly 128 on one side, and on the opposite side a first pad 130 and a second pad 132 configured to interface with the leading edge of the rectangular plates during use. In other embodiments, the stop block body 134 and the plate 136 can be integrated into a single component. The first and second pads 130 and 132 can be configured similarly to the pads 114 of the pedestal assembly 110 and can be made of a protective material with respect to the rectangular plates, such as plastic, rubber, etc., the first and second pads 130 and 132 may wear out and require replacement or a different pad material may be changed depending on rectangular plate material and/or loading configurations. In this regard, the first pad 130 can include a first structural engagement tab 138 and the second pad 132 can include a second structural engagement tab 140, with each of the first and second structural engagement tabs 138 and 140 configured to removably couple the respective first and second pads 130 and 132 to the stop block body 134 in a sliding manner. As an example, to replace one of the pads 130 and/or 132, the pads 130 and/or 132 can be slid vertically outward compared to the stop block body 134 until the respective structural engagement tab 138 and/or 140 disengages from the stop block body 134. A replacement pad 130 and/or 132 (new or different material) can then be slid laterally downward compared to the stop block body 134 to engage the respective structural engagement tab 138 and/or 140 to the stop block body 134. In other embodiments, other coupling configurations between the pads 130 and 132 and the stop block body 134 are within the scope of the present disclosure.

As shown in FIGS. 4B and 4C, the stop block 122 of the stop block assembly 120 can slide in a sliding direction SL along the rod 124 to adjust the stop block 122 with respect to the rectangular plate and secure the leading edge of the rectangular plate against the pads 130 and 132 to prevent forward shift of the plate during a braking event of the transport vehicle. As shown in FIG. 4B, the rod locking assembly 128 and the stop block 122 are positioned near a forward end of the rod 124 opposite the stop washer 126. This configuration shows an extended position of the stop block assembly 120 to accommodate, e.g., larger rectangular plates or plates positioned forward in the cargo area of the central portion 20. As shown in FIG. 4C, the rod locking assembly 128 in the stop block 122 are positioned near a midpoint of the rod 124, which shows an intermediate position of the stop block assembly 120 to accommodate, e.g., medium-size rectangular plates, etc. In other embodiments, the rod locking assembly 128 and the stop block 122 can be positioned at any location along the rod 124 to accommodate the size and/or location of the rectangular plate. In embodiments where the releasable locking member 129 is a friction plate stack, such as shown in the FIGURES, the rod locking assembly 128 can be slid along the rod 124 by rotation of the friction plate stack, e.g., clockwise in FIGS. 4B and 4C. In these embodiments, the friction plate stack can be biased toward the locked position, with the friction plate stack engaging the rod 124 to lock the axial position of the rod locking assembly 128. In other embodiments, other releasable locking members 129 are within the scope of the present disclosure, such as pins, threaded components, clamps, etc.

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 10% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. A load securement assembly for securing cargo to a trailer, the load securement assembly comprising:
a pedestal assembly configured to support the base of the cargo and having:
a first side plate and a second side plate arranged in a spaced apart configuration; and
a plurality of tubes extending through the first side plate and the second side plate, the plurality of tubes being spaced apart from each other; and
a stop block assembly configured to prevent translation of the cargo in a load securement direction and having:
a rod received within one of the plurality of tubes, the rod having a stop portion configured to interface with the pedestal assembly prevent axial translation of the rod out of the one of the plurality of tubes in the load securement direction; and
a stop block slidably associated with the rod, the stop block having a rod lock to releasably fix the stop block to the rod at an intermediate position along the rod, wherein the stop block is configured to interface with the cargo to prevent translation of the cargo in the load securement direction.

2. The load securement assembly of claim 1, wherein the stop block further includes a stop block body having a pad operably coupled thereto, and wherein the pad is configured to abut the cargo.

3. The load securement assembly of claim 1, wherein the plurality of tubes are spaced apart from each other in a direction along the length of the first and second side plates.

4. The load securement assembly of claim 3, wherein each of the plurality of tubes is configured to receive a stop block assembly, and wherein any number of stop block assemblies are associated with the pedestal assembly to prevent translation of the cargo in a load securement direction.

5. The load securement assembly of claim 4, wherein each tube position corresponds to a different area of the pedestal assembly supporting the cargo.

6. The load securement assembly of claim 1, further comprising a plurality of stop block assemblies received within the plurality of tubes, wherein:
the cargo comprises a plurality of panels having leading edges arranged at different positions along the trailer;
the stop block of one of the plurality of stop block assemblies is positionable to abut one of the leading edges of the plurality of panels; and
the stop block of another of the plurality of stop block assemblies is positionable to abut another of the leading edges of the plurality of panels in a different position along the trailer.

7. The load securement assembly of claim 1, wherein the pedestal assembly further comprises an outside plate and an inside plate extending between the first and second side plates to maintain the spacing therebetween.

8. The load securement assembly of claim 1, wherein the pedestal assembly further comprises a first pad operably coupled to an upper surface of the first side plate and a second pad operably coupled to an upper surface of the second side plate, wherein the pads are configured to abut the cargo.

9. The load securement assembly of claim 8, wherein the first and second pads each have an engagement tab, and wherein the first and second side plates each include a slot configured to receive the engagement tab to operably couple the first and second pads to the first and second side plates, respectively.

10. The load securement assembly of claim 1, wherein the rod lock comprises a friction plate stack to releasably fix the stop block to the rod at an intermediate position along the rod.

11. A vehicle trailer having a load securement assembly for securing panel cargo thereto, the vehicle trailer comprising:
a fifth-wheel coupling kingpin at a forward portion;
a central platform portion for carrying the panel cargo, the central platform portion having an A-frame structure including a vertical support member to laterally support the panel cargo;
a pedestal assembly operably coupled to the vertical support member and configured to support the base of the panel cargo, the pedestal assembly having:
a body; and
a plurality of tubes extending through the body and spaced apart from each other along the body in a lateral direction of the vehicle trailer; and
a stop block assembly configured to prevent translation of the panel cargo in a load securement direction toward the fifth-wheel coupling kingpin, the stop block assembly having:
a rod received within one of the plurality of tubes, the rod having a stop portion configured to interface with the pedestal assembly prevent axial translation of the rod out of the one of the plurality of tubes in the load securement direction; and
a stop block slidably associated with the rod and fixable with respect to the rod at an intermediate position along the rod, wherein the stop block is configured to interface with the panel cargo to prevent translation of the panel cargo in the load securement direction.

12. The vehicle trailer of claim 11, wherein the pedestal assembly comprises a first pedestal assembly operably coupled to a first vertical support member of the A-frame structure and a second pedestal assembly operably coupled to a second vertical support member of the A-frame structure, wherein the first pedestal assembly is positioned nearer to the fifth-wheel coupling kingpin.

13. The vehicle trailer of claim 11, wherein the stop block further includes a pad configured to abut the panel cargo during use of the load securement assembly.

14. The vehicle trailer of claim 11, wherein each of the plurality of tubes is configured to receive a stop block assembly, and wherein any number of stop block assemblies are associated with the pedestal assembly to prevent translation of the panel cargo in a load securement direction.

15. The vehicle trailer of claim 14, wherein each tube position corresponds to a different portion of the pedestal assembly supporting the panel cargo.

16. The vehicle trailer of claim 11, further comprising a plurality of stop block assemblies received within the plurality of tubes, wherein:
the panel cargo comprises a plurality of panels having leading edges arranged at different positions along the trailer;
the stop block of one of the plurality of stop block assemblies is positionable to abut one of the leading edges of the plurality of panels; and
the stop block of another of the plurality of stop block assemblies is positionable to abut another of the leading edges of the plurality of panels in a different position along the trailer.

17. The vehicle trailer of claim 11, wherein the pedestal assembly further comprises a first side plate, a second side plate in a spaced apart configuration, and an outside plate and an inside plate extending between the first and second side plates to maintain the spacing therebetween.

18. The vehicle trailer of claim 11, wherein the pedestal assembly further comprises a pad operably coupled to an upper surface of the pedestal assembly, wherein the pad is configured to abut the cargo.

19. The vehicle trailer of claim 18, wherein the pad has an engagement tab, and wherein the pedestal assembly includes a slot configured to receive the engagement tab to operably couple the pad to the pedestal assembly for pad replacement.

20. The vehicle trailer of claim 11, further comprising a rod lock operable with the stop block, wherein the rod lock comprises a friction plate stack to releasably fix the stop block to the rod at an intermediate position along the rod.
